(19) United States
(12) Patent Application Publication
(10) Pub. No.: US 2007/0044540 A1
(43) Pub. Date: Mar. 1, 2007

(54) RADIATION SOURCE FOR GAS SENSOR

(75) Inventors: Kazuaki Ohkubo, Osaka (JP); Mitsuhiko Kimoto, Nara (JP)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 11/551,502

(22) Filed: Oct. 20, 2006

Related U.S. Application Data
(62) Division of application No. 10/769,721, filed on Jan. 30, 2004.

(30) Foreign Application Priority Data
Feb. 17, 2003 (JP) 2003-037869

(51) Int. Cl. G01N 7/00

(52) U.S. Cl. 73/23.2

(57) ABSTRACT

A gas sensor radiation source includes a filament in which microcavities having an opening diameter of about half of the absorption spectrum wavelength of a gas whose concentration is to be measured and a depth of twice or more greater than the opening diameter and a bulb enclosing, at a reduced pressure or with a noble gas enclosed therein, a filament. Thus, radiation can be efficiently made in accordance with the absorption spectrum of the gas to be detected.

### BACKGROUND OF THE INVENTION

The present invention relates to a gas sensor and a gas sensor filament for use in measurement of concentrations of various types of gases.

It is known that each type of gases absorbs light (electromagnetic wave) having a specific wavelength in the infrared radiation region, the ultraviolet radiation region and the like. By utilizing this feature, gas sensors and gas detectors for measuring the concentration of a gas have been developed. In general, gas sensors and gas detectors using infrared radiation have been widely used.

Such a gas sensor or a gas detector includes an infrared radiation source and an infrared radiation sensor arranged with a predetermined gas detection space therebetween and makes a gaseous body flow in the gas detection space and measures the amount of a detection target gas contained in the gaseous body by detecting with a sensor infrared radiation attenuation generated in accordance with the amount of the detection target gas, i.e., the amount of infrared radiation absorbed by the detection target gas.

In this case, as an infrared radiation source, an incandescent lamp having a filament obtained by winding a tungsten wire as a coil is mainly used and infrared radiation from the filament caused when the filament is conductive-heated to reach 600-800 K is used.

Spectral radiant exitance M (λ, T) is the ratio of radiation of light having a wavelength λ to radiation of light (electromagnetic wave) from a tungsten filament of a temperature T. The spectral radiant exitance M (λ, T) of the tungsten filament can be represented by the product of the emissivity ε of the filament and the spectral radiant exitance Mb (λ, T) of blackbody radiation. FIG. 1 is a graph showing the spectral radiant exitance Mb (λ, T) of blackbody radiation at every 100 K between 400 K and 800 K.

The emissivity ε (λ, T) of the tungsten filament is 20% or less in a wavelength range of 2 μm or more which is used as a gas sensor between 500 K and 1000 K. The ratio of utilizable energy is small. Furthermore, even if the temperature of the filament is set at about 2000 K to increase the entire energy of radiation from the filament, a wavelength at which the energy becomes maximum shifts to the short wavelength side as Wien's displacement law explains, and the emissivity of the tungsten filament in the infrared wavelength range used as a gas sensor is also 20% or less. Thus, the tungsten filament is considered to have very poor efficiency as a radiation source for a gas sensor.

On the other hand, the wavelength of infrared radiation absorbed by a gas is different depending on a gas to be detected. For example, carbon dioxide (CO₂) absorbs infrared radiation having a wavelength of 4.26 μm and carbon monoxide (CO) absorbs infrared radiation having a wavelength of 4.67 μm. Moreover, the absorption wavelength range of nitrogen oxide (NO,ₓ) is 6-9 μm. With the known tungsten filament, as described above, it is difficult to efficiently irradiate these infrared radiations.

To solve the problems, attempts have been made to efficiently obtain infrared radiation by using as a filament which is to be a heat element wire an alloy filament formed of an alloy, such as nickel-chromium alloy, iron-chromium-aluminum alloy, which has high infrared emissivity and is hardly oxidized and, furthermore, coating the surface of the alloy filament with ceramic having high emissivity in the infrared wavelength band (e.g., Japanese Unexamined Patent Publication No. 2002-22263 8).

However, according to the method disclosed in Japanese Unexamined Patent Publication No. 2002-222638, the emissivity is improved in a wide wavelength range. Accordingly, when only concentrated radiation in the absorption wavelength band of a specific gas is required as in gas detection, as for a radiation source used in the method, the ratio of the amount of the concentrated radiation to energy (electric power in many cases) to be input is low. That is to say, efficiency of the radiation source is still low. Therefore, when the alloy filament is used as a gas sensor, a cooling device is further needed.

Moreover, to use an infrared radiation source of Japanese Unexamined Patent Publication No. 2002-222638 as a gas sensor, only a necessary wavelength band of light emitted from a light source is obtained by making the light pass through an interference filter before the light enters into a gas to be measured. However, such an interference filter is expensive, in general, and thus the price of a sensor becomes expensive.

On the other hand, as a method for obtaining concentrated radiation in a required wavelength band, a method using a laser or an LED is used. However, as of today, no laser or LED which can efficiently perform radiation of the infrared region (i.e., having a wavelength of 2-9 μm) has not been developed yet. Moreover, although a laser or LED which can perform radiation of the ultraviolet region (including an absorption wavelength of a gas) is used as a radiation source of a gas sensor, the laser or LED is not suitable for being used as a simple gas concentration detector which is included as a safety device in a general combustior such as a gas sensor and a gas detector in terms of device size and costs.

It is therefore an object of the present invention is to provide a small-size and low-cost gas sensor and gas sensor filament which allow efficient radiation of an electromagnetic wave in an absorption wavelength range of a gas to be detected.

### SUMMARY OF THE INVENTION

A gas sensor filament according to the present invention is a gas sensor filament which emits an electromagnetic wave in order to measure the concentration of a gas includes a plurality of holes having a diameter of about half of a wavelength of the electromagnetic wave absorbed by the gas on a surface of the filament.

It is preferable that the diameter of the holes is not less than 45% and not more than 55% of the wavelength of the electromagnetic wave absorbed by the gas.

In an embodiment of the present invention, the filament further includes a planar portion. In the filament, the holes are provided in the planar portion.

In another embodiment of the present invention, the filament further includes a portion formed of a metal sheet. In the filament, the holes are provided at least on one surface of the metal sheet.

It is preferable that at least part of the surface other than part of the surface in which the holes are provided are mirror-processed.

In a preferable embodiment of the present invention, the gas is carbon monoxide (CO) or carbon dioxide (CO₂), and the diameter of the holes is 2.3 μm.

In another preferable embodiment of the present invention, the gas is methane (CH₄), and the diameter of the holes is 1.7 μm.

A gas sensor according to the present invention is a gas sensor for measuring the concentration of a gas, including a radiation source; a vessel in which the gas is filled; and a detector for detecting radiation of an electromagnetic wave from the radiation source. In the gas sensor, the radiation source includes a filament in which a plurality of holes having a diameter of about half of a wavelength of an electromagnetic wave absorbed by the gas and which generates the radiation, the vessel includes an entrance window through which the radiation from the radiation source enters and an exit window through which the radiation is emitted to the detector, and the detector includes a detecting surface receiving the radiation emitted from the exit window.

It is preferable that the diameter of the holes is not less than 45% and not more than 55% of the wavelength of the electromagnetic wave absorbed by the gas.

In an embodiment of the present invention, the radiation source further includes a bulb having, at a reduced pressure or with a noble gas enclosed therein, the filament in an internal space.

In another embodiment of the present invention, the filament includes a planar portion, the holes are provided in the planar portion, and the planar portion in which the holes are formed faces the detecting surface.

It is preferable that the angle between a line intersecting perpendicularly with the planar portion in which the holes are provided and the detecting surface is not less than 80 degree and not more than 100 degree.

In a preferable embodiment of the present invention, the gas includes a first gas for absorbing an electromagnetic wave having a first wavelength and a second gas for absorbing an electromagnetic wave having a second wavelength, and the radiation source includes a first filament in which a plurality of holes having a diameter of about half of the first wavelength are formed and a second filament in which a plurality of holes a diameter of about half of the second wavelength are formed.

### BRIEF DESCRIPTION OF THE DRAWINGS

FIG. 1 is a graph of spectral radiant exitance for blackbody radiation between 400 K and 800 K.

FIG. 2 is a graph showing a difference in emissivity between filaments with and without microcavities formed.

FIG. 3 is a graph of spectral emissivity for a filament according to EMBODIMENT 1.

FIG. 4 is a graph of spectral radiant exitances at different temperatures for the filament of EMBODIMENT 1.

FIG. 5 is a graph showing the dependency of the ratio of radiation in a wavelength range of 3.2-3.7 μm to radiation in a wavelength range of 1-5.2 μm on distribution temperature.

FIG. 6 is a graph showing luminous intensity distribution properties of a filament in which microcavities are formed.

FIG. 7 is a schematic view of a gas sensor according to EMBODIMENT 2.

FIG. 8 is a schematic view of a radiation source according to EMBODIMENT 2.

FIG. 9 is a schematic view of a gas sensor according to EMBODIMENT 3.

FIG. 10 is a schematic view of a radiation source according to EMBODIMENT 3.

FIG. 11A is an illustration of a filament according to EMBODIMENT 1.

FIG. 11B is an enlarged view of a portion R of FIG. 11A.

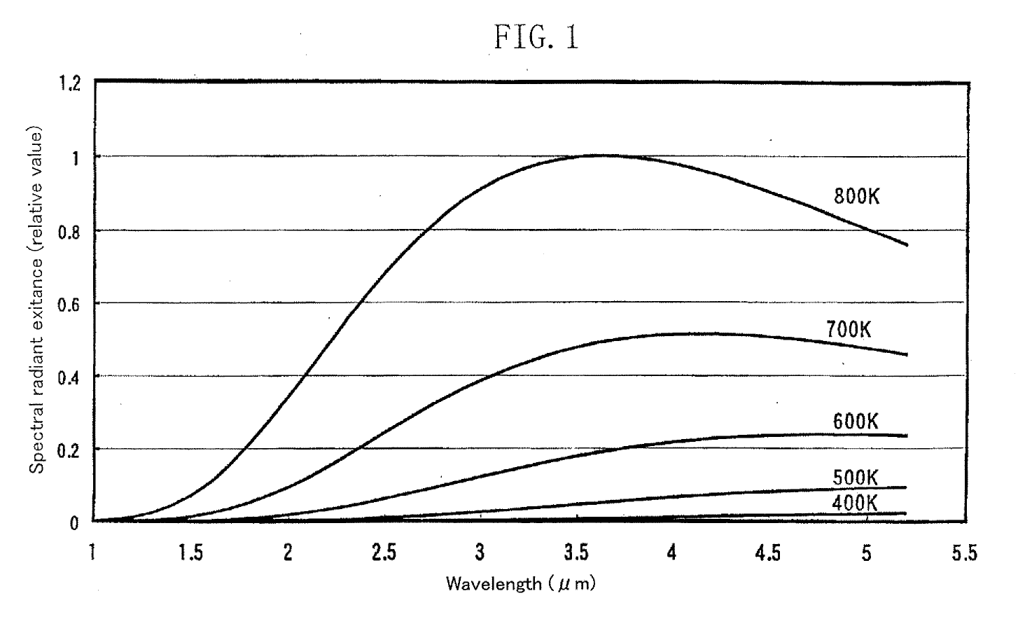

### DESCRIPTION OF THE PREFERRED EMBODIMENTS

Hereinafter, items which the present inventors have examined for the present invention will be described first and then embodiments of the present invention will be described based on the accompanying drawings. Note that the present invention is not limited to the following embodiments.

In Japanese Unexamined Patent Publication No. 3-102701, a technique relating to a light source which suppresses the generation of radiation of light having a greater wavelength than a predetermined cut-off wavelength and thereby efficiently emits visible light is disclosed. A tungsten incandescent lamp described in Japanese Unexamined Patent Publication No. 3-102701 is as follows. The tungsten incandescent lamp has a waveguide cavity with a square opening formed on a tungsten surface. From the tungsten incandescent lamp, light (photon) having a greater wavelength than twice of the length of a side of the square opening is not emitted and only light having a smaller wavelength than the cut-off wavelength (a wavelength equal to twice of the length of a side of the square) is emitted. When Japanese Unexamined Patent Publication No. 3-102701 was disclosed, it was very difficult to form such a cavity in a tungsten filament. Thus, the above-described technique is considered to be based on an inference made from the waveguide theory, However, recently, as disclosed in Japanese Unexamined Patent Publication No. 2001-314989, a technique for forming a plurality of holes (i.e., microcavities) having a size of about half of an infrared wavelength by using a femto-second laser in a metal sheet (e.g., a tungsten sheet) was developed. Then, the present inventors conducted the following examination using the technique of Japanese Unexamined Patent Publication No. 2001-314989.

First, a plurality of holes (which will be herein referred to as “microcavities”) having different opening diameters, i.e., 0.7, 1.4 and 1.6 μm, were formed using a femto-second laser on surfaces of three tungsten sheets each of which has a length of 20 mm, a width of 0.17 mm and a thickness of 5 μm, respectively, so that a hole pitch (i.e., the distance between the centers of adjacent ones of the microcavities) was twice of an associated one of the opening diameters and the depth of each of the microcavities was 3-4 μm. Thus, three different samples were formed. Each of the microcavities has an oval shape. Note that detailed description of microcavity formation using a femto-second laser is disclosed in Japanese Unexamined Patent Publication No. 2001-314989 and, therefore, the detailed description thereof is omitted.

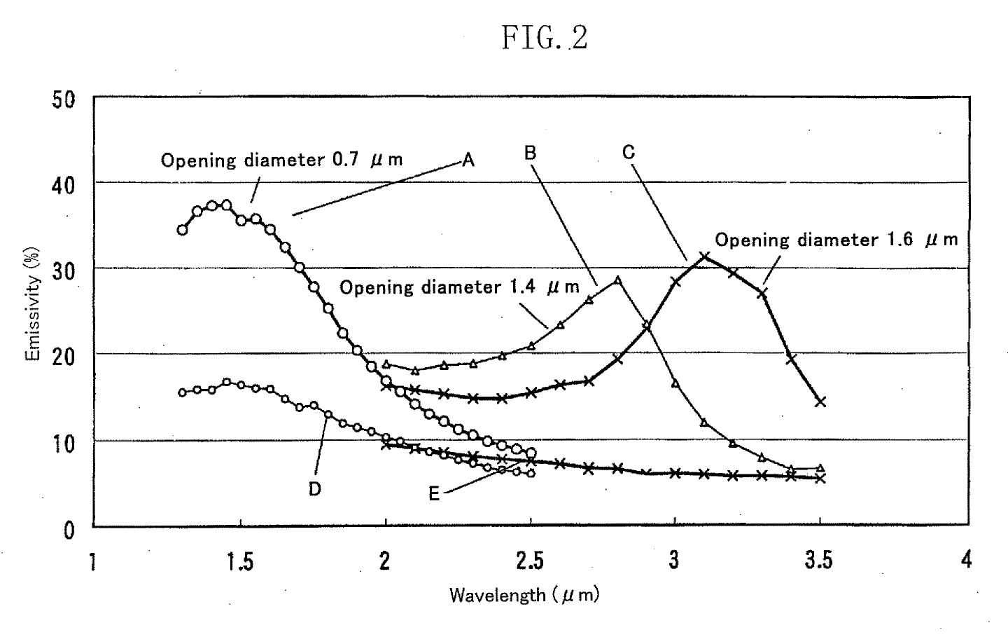

FIG. 2 is a graph showing the relationship between radiation wavelength and emissivity measured after the samples with the microcavities and a tungsten sheet with no microcavity were heated to 600 K. A is a microcavity formed sample with microcavities having an opening diameter of 0.7 μm. B is a microcavity formed sample with microcavities having an opening diameter of 1.4 μm. C is a microcavity formed sample with microcavities having an opening diameter of 1.6 μm. D and E are data for tungsten sheets with no microcavity.

It can be understood from FIG. 2 that each of the microcavity formed samples generates radiation having a spectrum in which the emissivity has a peak at a wavelength of twice of the opening diameter of microcavities. This is a different phenomenon from the waveguide theory described in Japanese Unexamined Patent Publication No. 3-102701 in which with a cut-off wavelength (i.e., a wavelength of twice of the diameter of an opening) as a dividing line, radiation having a greater wavelength than the cut-off wavelength disappears and radiation of a smaller wavelength is continuously made. More specifically, more radiation having a wavelength of twice of the diameter of an opening is made from the microcavity formed samples than radiation in any other wavelength range, and when the wavelength of the radiation becomes greater or smaller than twice of the opening diameter, radiation is rapidly reduced. The phenomenon is characterized in that radiation in the short wavelength side is reduced. This is first discovered by the present inventors. The detailed mechanism of this phenomenon is unknown. However, it is possible to achieve a radiation source which selectively increases emissivity only in a specific wavelength band by using this phenomenon. That is to say, if this phenomenon is used for a radiation source of a gas sensor, a radiation source with high energy efficiency can be obtained.

### Embodiment 1

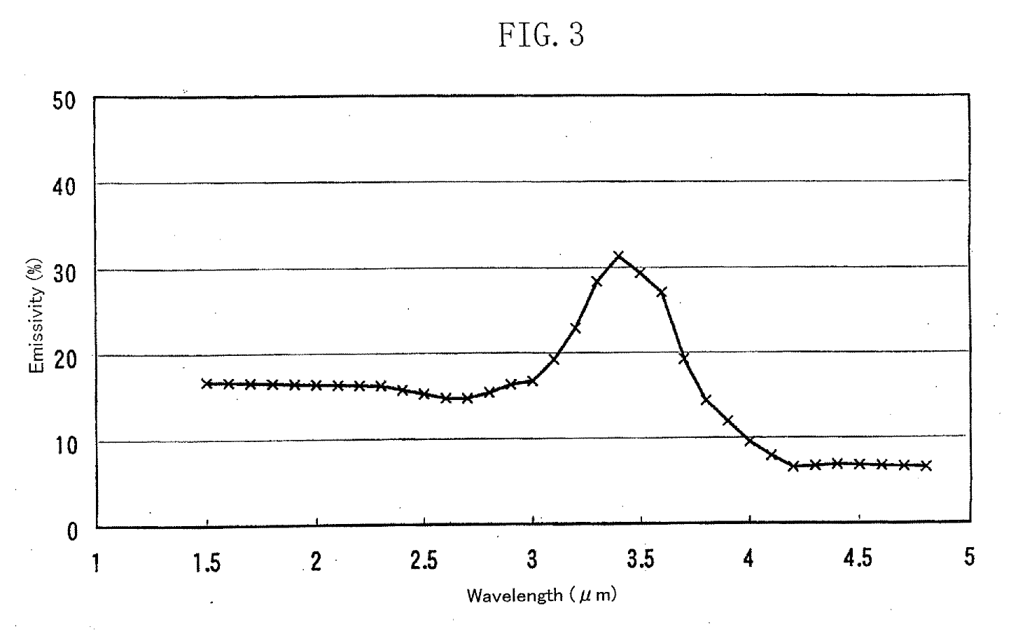

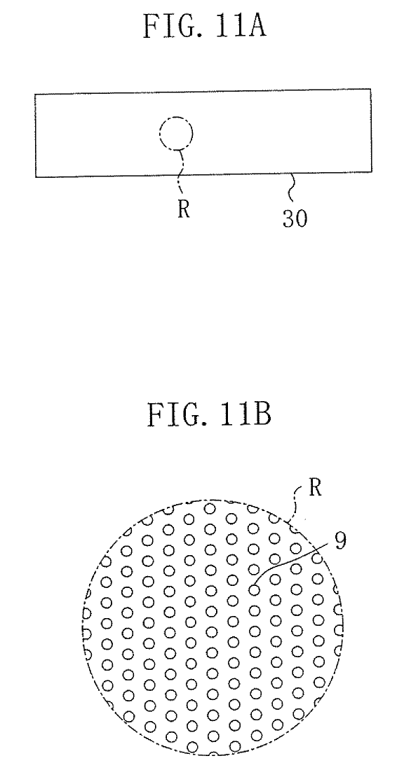

EMBODIMENT 1 is a light source for methane (CH₄) gas detection using the above-described phenomenon. The light source, as shown in FIG. 11A, is a filament 30 formed of a tungsten sheet. A plurality of holes (microcavities) 9 are formed on almost an entire surface of the filament. The microcavities 9 have an approximately oval shape. In this case, the absorption wavelength of methane is 3.39 μm. Thus, as shown in FIG. 11B illustrating a portion B of FIG. 11A enlarged, the microcavities 9 are formed on the surface of the filament 30 with a 3.4 μm distance between the centers of two adjacent ones of the microcavities 9 so as to have a diameter of about half of the absorption wavelength of methane, i.e., 1.7 μm, and so as not to be in contact with each other. In this case, the depth of each of the microcavities 9 is set to be about 4 μm. FIG. 3 is a graph of emissivity (%) with respect to a wavelength of an electromagnetic wave emitted from the filament 30 when the filament 30 is heated to 600 K. As can be understood from FIG. 3, the emissivity is the maximum when the wavelength is about 3.4 μm. That is to say, by providing a large number of the microcavities 9 on the surface of the filament 30, an electromagnetic wave having a spectrum with a peak at a wavelength of about twice of the opening diameter of the microcavities 9 is selectively emitted from the filament 30.

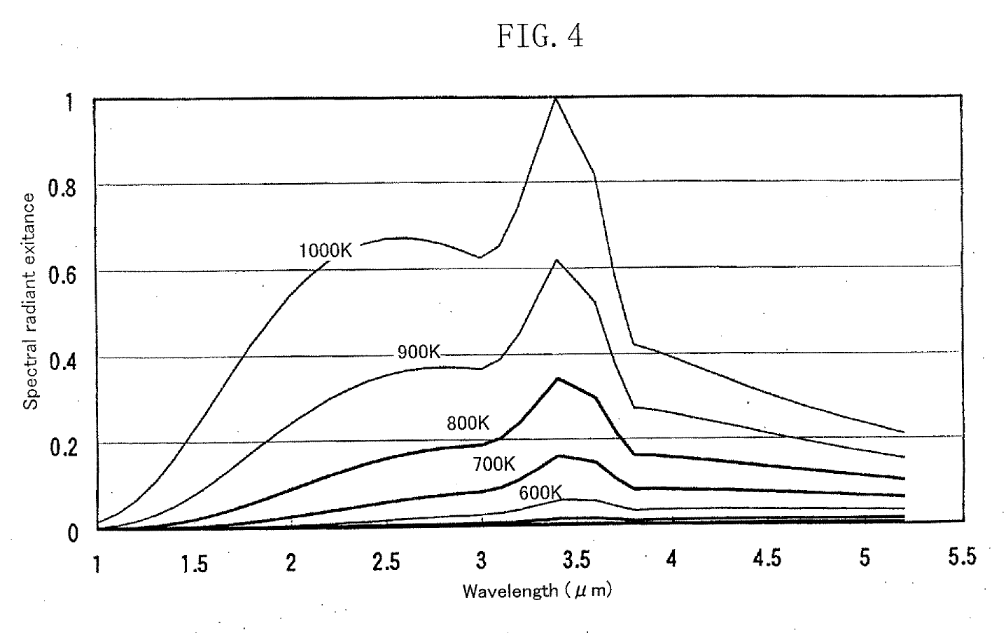

FIG. 4 is a graph showing relative values for spectral radiant exitance to a radiation wavelength when the filament 30 is heated in a temperature range from 400 K to 1000 K. From FIG. 4, it can be seen that the maximum value is located at a wavelength of 3.4 μm and the spectral radiant exitance is increased in a wavelength range from 3.2 μm to 3.7 μm, compared to other wavelength ranges.

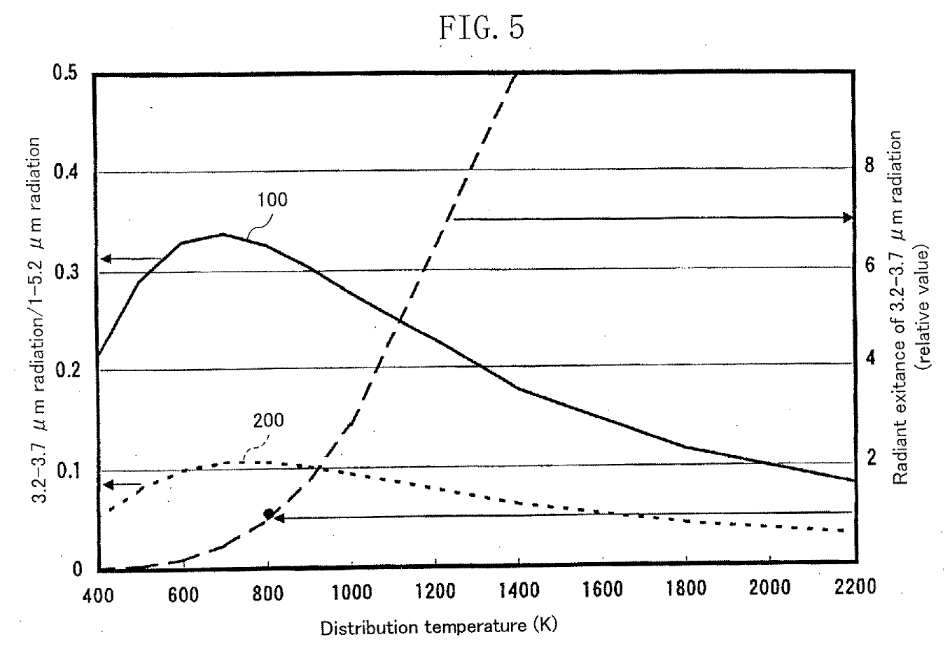

FIG. 5 is a graph in which the abscissa indicates the distribution temperature (K) of the filament 30 and the ordinate indicates the ratio of the integral value of the spectral radiant exitance at a wavelength of 3.2-3.7 μm to the integral value of the spectral radiant exitance at a wavelength of 1-5.2 μm. Moreover, at the same time, FIG. 5 also shows a relative value, obtained with the integral value when the distribution temperature of the filament 30 is 800 K represented as 1, for the integral value of the spectral radiant exitance of the filament 30 in which the microcavities are formed at a wavelength of 3.2-3.7 μm. Note that in FIG. 5, also for a filament with no microcavity formed, the ratio of the integral value of the spectral radiant exitance at a wavelength of 3.2-3.7 μm to the integral value of the spectral radiant exitance at a wavelength of 1-5.2 μm and a relative value, obtained with the integral value when the distribution temperature of the filament is 800 K represented as 1, are shown in the same manner as that describe above.

A reason why the integral value of the spectral radiant exitance at a wavelength of 1-5.2 μm as the denominator of the ratio of the integral value of the spectral radiant exitance at a wavelength of 3.2-3.7 μm to the integral value of the spectral radiant exitance at a wavelength of 1-5.2 μm is that most of electromagnetic waves emitted from a filament have a wavelength of 1 μm or more at a temperature used for a gas sensor. Also, another reason is that sapphire glass is used for a measurement window provided in a vessel in which a gas to be measured is filled, and 50% of infrared radiation having a wavelength of 5.2 μm is transmitted through sapphire glass but infrared radiation having a greater wavelength than 5.2 μm hardly transmits through sapphire glass. Note that if soda glass is used as a material for a window, infrared radiation of a wavelength of 3-4 μm at most transmits through soda glass in the long wavelength side.

The spectral radiant exitance Mb (λ, T) of blackbody radiation has a peak at a wavelength of 3.7 μm at a temperature of around 700 K. Accordingly, the ratio 200 of the integral value of the spectral radiant exitance at a wavelength of 3.2-3.7 μm to the integral value of the spectral radiant exitance at a wavelength of 1.5-2 μm for the filament in which no microcavity is formed is the maximum at a distribution temperature of around 700 K. However, the ratio 100 of the integral value of the spectral radiant exitance at a wavelength of 3.2-3.7 μm to the integral value of the spectral radiant exitance at a wavelength of 1.5-2 μm for the filament 30 in which the microcavities are formed so that the emissivity ε (λ, T) is the maximum at a wavelength of 3.4 μm is three times or more greater than that of the filament in which no microcavity is formed at a distribution temperature of 700 K.

The ratio of the integral value of the spectral radiant exitance at a wavelength of 3.2-3.7 μm to the integral value of the spectral radiant exitance at a wavelength of 1-5.2 μm is the ratio of radiation in a wavelength band used in measuring the concentration of a gas to an entire radiation from a light source and indicates the radiant efficiency of the light source. Therefore, as can be understood from FIG. 5, in a distribution temperature range from 400 K to 1300 K, the filament in which the microcavities are formed has twice or more higher efficiency than the maximum efficiency of a known, general filament.

On the other hand, the spectral radiant exitance of the filament 30 in which the microcavities are formed at a wavelength of 3.2-3.7 μm is reduced when a distribution temperature is reduced, and the spectral radiant exitance at a wavelength of 3.2-3.7 μm and at a temperature of 600 K is 20% or less of that at a temperature of 800 K. To detect a gas, a predetermined irradiance is required when radiation from a light source is absorbed by the gas and then emitted to a sensor section. Thus, it is desirable to use the filament at a distribution temperature of 600 K or more.

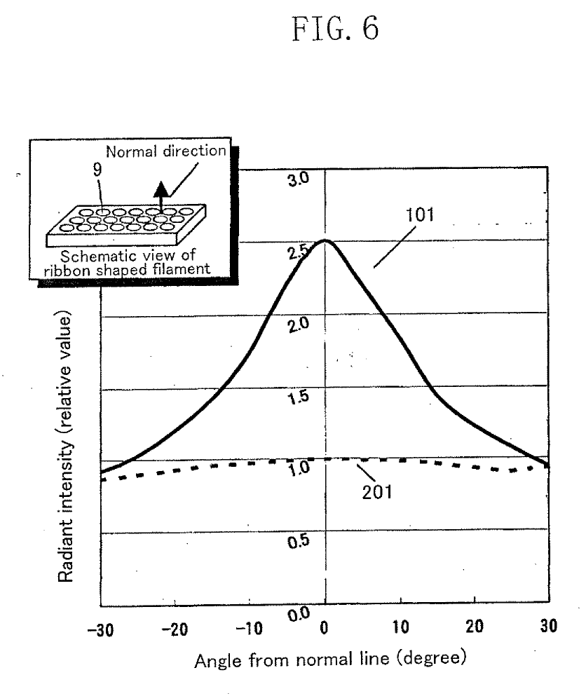

Moreover, the present inventors found that by forming microcavities in a plane sheet to obtain a filament, radiation from the filament has a directivity. Note that this is not described in Japanese Unexamined Patent Publication No. 3-102701 and is a finding first made by the present inventors. FIG. 6 is a graph showing luminous intensity distribution properties (the relationship between an angle from a normal line of a filament plane and radiant intensity) of a plane sheet in which microcavities are formed. As shown in the luminous intensity distribution properties of FIG. 6, the filament in which no microcavity is formed has substantially a constant radiant intensity in a angle range of ±30 degree from the normal line of a plane constituting a filament and does not have a directivity. However, the filament in which the microcavities are formed in the above-described manner has the maximum radiant intensity in the normal direction and a directivity in which the half width of the radiant intensity is an angle of ±10 degree from a normal line. By using this directivity, for example, unlike a reflector bulb, a light source having a luminous intensity distribution with a directivity can be achieved even without a reflective optical system.

A known gas sensor collects light emitted from a filament with no directivity and with near perfect diffusion on a receiving surface (detecting surface) of a detector by using an optical system such as a reflector or a lens to effectively emit light from the filament to the receiving surface. However, as has been described, by forming microcavities so as to allow radiation to have a directivity, small-size and low-cost radiation source and gas sensor which do not use an optical system can be achieved.

Note that the half width indicating the broadening of directivity (i.e., a beam angle) can be increased or reduced by curving a ribbon filament itself. For example, a beam angle of ±15 degree corresponding to a diffusion reflector bulb can be achieved.

Furthermore, when the microcavities are formed in the filament, at least other part of the filament surface than part of the filament surface in which microcavities are formed is subjected to mirror processing, thereby suppressing the emissivity. As a result, heat radiation from the filament can be suppressed so that the radiant efficiency of infrared radiation in a target wavelength range can be improved. The other part of the filament surface than the part of the filament surface in which microcavities are formed means to include, for example, part of the filament surface located between adjacent two of the microcavities and, if the microcavities are formed in a region of the filament surface, part of the filament surface other than the region in which the microcavities are formed. Note that to perform mirror processing to the other part of the filament surface than the part of the filament surface in which microcavities are formed, the entire filament may be first subjected to minor polish and then microcavities may be formed by a femto-second laser.

Moreover, in this embodiment, the depth of the microcavities 9 is about 2.5 times greater than the opening diameter thereof. However, the above-described effects can be achieved when the depth of the microcavities 9 is twice or more greater than the opening diameter. In Japanese Unexamined Patent Publication No. 3-102701, the depth of microcavities is about 20 times greater than the diameter of an opening, but in such a case, it is difficult to form such a deep hole, resulting in increase in fabrication costs. However, in this embodiment, since the depth of the microcavities 9 may be twice or more greater than the opening diameter, and thus microcavities can be formed in a simple manner and increase in fabrication costs can be suppressed.

### Embodiment 2

In EMBODIMENT 2, a filament in which microcavities are formed and a gas sensor using the filament as a radiation source will be described. Moreover, the type of a gas to be measured is methane.

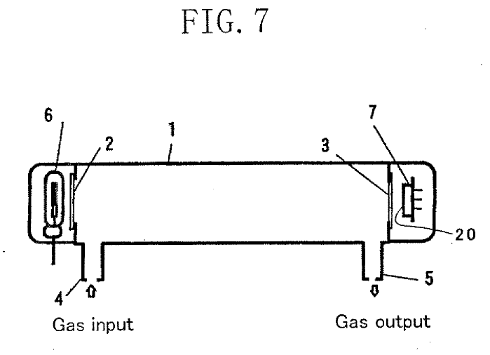

The internal configuration of a gas sensor according to this embodiment will be described in FIG. 7. The gas sensor includes a radiation source 6, a vessel (cell) 1 in which a gas to be measured is filled, and a detector 7 for detecting radiation of an electromagnetic wave (infrared ray). An entrance window 2 and an exit window 3 are provided at both ends of the cell 1 in which the gas to be measured is filled, and the exit window 3 includes an optical filter. Moreover, the gas to be measured is introduced through a gas entry section 4 into the cell 1 so that the cell 1 is filled with the gas and then the gas is exhausted through a gas outlet section 5. Radiation from the radiation source 6 enters in the cell 1 through the entrance window 2, transmits through the gas with which the cell 1 is filled, passes through the exit window 3 and then enters into a detecting surface 20 of the detector 7. The detector 7 converts the amount of radiation received by the detecting surface 20 into an electric signal. In this case, if methane (CH₄) gas is contained in the gas to be measured, part of radiation generated from the radiation source 6 and having a wavelength of 3.39 μm is absorbed by methane. Thus, by comparing an output of the detector 7 to that obtained when methane is not contained in the gas, the concentration of methane contained in the gas to be measured can be determined quantitatively.

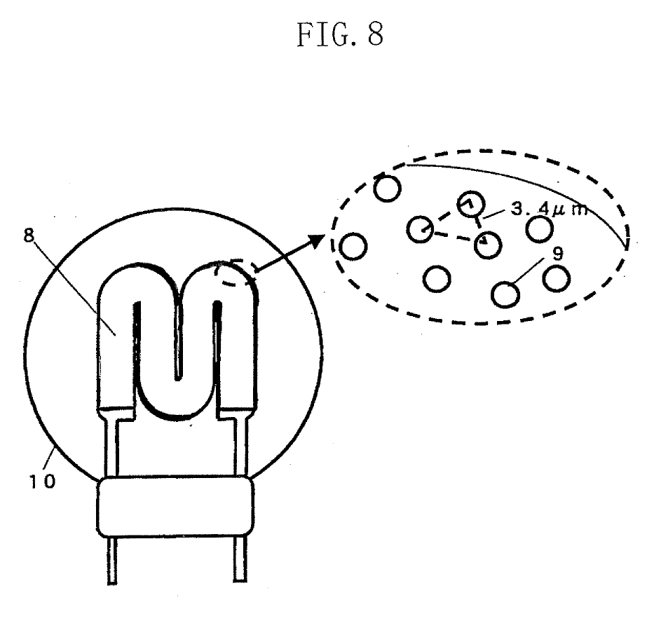

FIG. 8 illustrates the configuration of the gas sensor radiation source 6. A cut is formed in a tungsten sheet by etching to obtain a filament 8 with a tungsten ribbon winding to form an M shape. The filament 8 exists substantially in a plane. Then, on one surface of the filament 8, microcavities 9 are formed by a femto-second laser so that the opening diameter thereof is 1.7 μm and a hole pitch (i.e., the distance between the respective centers of adjacent ones of the microcavities) is 3.4 μm. The microcavities are processed so that the opening diameter thereof is about half of the wavelength (3.39 μm) of an absorption spectrum of the gas (methane) of which the concentration is to be measured and the depth thereof is twice or more greater than the opening diameter. A microcavity forming surface is a surface of the tungsten sheet facing up in FIG. 8 and also a surface facing the detecting surface in FIG. 7. Moreover, the filament 8 is enclosed together with argon gas in a bulb 10. The surface of the filament 8 in which the microcavities 9 are formed is substantially a plane, faces the detecting surface 20 and also faces a surface in the entrance window side. In this case, the angle between a line intersecting perpendicularly with the surface of the filament 8 in which the microcavities 9 are formed and the detecting surface 20 is substantially 90 degree. However, as long as the angle is in an 80-100 degree range, the detecting surface 20 can receive radiation with sufficiently high efficiency.

By forming the microcavities 9 in the filament 8, an electromagnetic wave having a spectrum with a peak at a predetermined wavelength (3.4 μm in this case) can be emitted from the filament 8 and radiation having a directivity in which the radiation intensity is specifically large in the normal direction of the microcavity forming surface (substantial plane) of the filament 8 can be generated. Then, as for the degree of the directivity, the half width of the radiant intensity is ±10 degree. Accordingly, a light source (radiation source) having a luminous intensity distribution with a directivity can be achieved without a reflective optical system. Therefore, unlike the known gas sensor, an optical system such as a reflector is not needed to be provided in a radiation source. Thus, a very small radiation source section can be formed.

The optical filter of the exit window 3 is provided so as to separate infrared radiation having the absorption wavelength of another gas and prevent the infrared ray from entering in the detector 7 when the absorption wavelength of the gas to be measured is close to the absorption wavelength of another gas. For example, in the case of methane, the absorption wavelength thereof is 3.39 μm. Since the absorption wavelength of carbon dioxide (CO₂) is 4.26 μm and the absorption wavelength of carbon monoxide (CO) is 4.67 μm, a band transmission filter having a center wavelength of 3.4 μm and a band half width is of 1 μm is used to exclude influences of carbon dioxide and carbon monoxide.

As the detector 7, for example, a pyro sensor is used. The pyro sensor is a type of thermal detectors, which absorbs radiation in a receiving surface (detecting surface) and then obtains radiant power from a rise in temperature of a detecting surface. The pyro sensor is a differential response type sensor and, therefore, normally modulates radiation by a photochopper to perform detection. However, in this embodiment, the radiation source 6 is used by electrically flashing the radiation source 6 at 15 Hz. Note that instead of flashing the radiation source 6, a photochopper including a rotating sector may be provided between the exit window 3 and the radiation detector 7.

Moreover, the gas to be measured is not limited to methane but some other gas may be a target gas to be measured. In that case, the wavelength of an electromagnetic wave to be absorbed is different depending on the type of a gas to be measured. Therefore, the opening diameter of microcavities in accordance with the absorption wavelength may be selected. Then, if the opening diameter of the microcavities is determined to be 2.3 μm, radiation from the filament is infrared radiation having a spectrum with a peak at a wavelength of 4.6 μm. In this case, each of the absorption wavelengths of carbon dioxide and carbon monoxide is contained in the spectrum. Thus, each of the concentrations of carbon dioxide and carbon monoxide can be measured with the filament.

### Embodiment 3

In EMBODIMENT 3, a gas sensor for detecting the concentrations of a plurality of gases of different types and a radiation source used for the gas sensor.

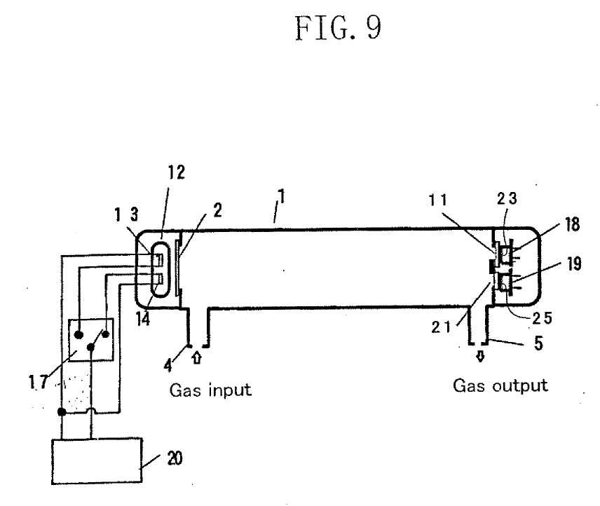

FIG. 9 illustrates a gas sensor according to this embodiment. A cell 1 and an entrance window 2 of the gas sensor of this embodiment are the same as those of EMBODIMENT 1. Thus, other components of the gas sensor will be described.

A radiation source 12 includes two filaments, i.e., a first filament 13 and a second filament 14. A detector section includes, correspondingly to the two filaments, a first detector 18 and a second detector 19. A first exit window 11 including a first optical filter is provided on the front face of a detecting surface (first detecting surface) 23 of the first detector 18, and a second exit window 21 including a second optical filter is provided on the front face of a detecting surface (second detecting surface) 25 of the second detector 19. Radiation from the radiation source 12 enters the cell 1 through the entrance window 2 and part of the radiation is absorbed by a gas in the cell 1. The rest of the radiation passes through the first exit window 11 and the second exit window 21 and is emitted to the first and second detecting surfaces 23 and 25. Then, each of the first and second detectors 18 and 19 converts the amount of radiation received by the first and second detecting surface 23 or 25 into an electric signal.

If two types of gases, e.g., methane and carbon dioxide are contained in the cell 1, infrared radiation having a wavelength of 3.39 μm is specifically absorbed by methane and infrared radiation having a wavelength of 4.26 μm is specifically absorbed by carbon dioxide. In such a case, using a band transmission filter having a center wavelength of 3.4 μm and a band half width of 1 μm as the first optical filter, a remaining portion of the infrared ray having a wavelength of 3.39 μm which has been left after absorption by methane is made to enter into the first detector 18. Moreover, using a band transmission filter having a center wavelength of 4.26 μm and a band half width of 1 μm as the second optical filter, a remaining portion of the infrared ray having a wavelength of 4.26 μm which has been left after absorption by carbon dioxide is made to enter into the second detector 19. A detector output (detection signal) of the remaining portion from absorption by methane or carbon dioxide detected in this manner and respective detector outputs of the detectors 18 and 19 when methane or carbon dioxide does not exist in the cell 1 are compared to each other, thereby quantitatively determining the concentration of methane or carbon dioxide contained in the gas to be measured in the cell 1.

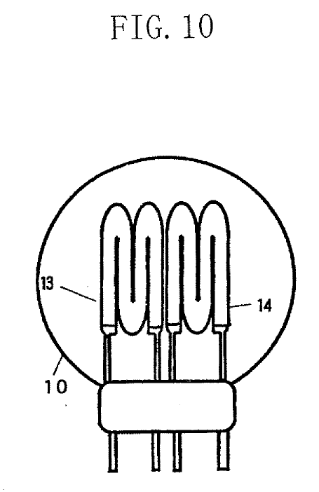

In this embodiment, methane as the first gas and carbon dioxide as the second gas are two target gases to be measured and the radiation source 12 is formed so as to correspond to the two types of gases. FIG. 10 illustrates the radiation source 12 of this embodiment.

The radiation source 12 of this embodiment includes two independent filaments, i.e., filaments 13 and 14. Each of the two filaments 13 and 14 is formed of the same material as that used for the filament of EMBODIMENT 1 and has substantially the same shape as that in EMBODIMENT 1. That is to say, each of the filaments 13 and 14 includes a tungsten ribbon winding to form an M shape and is formed as a whole in a plane. A large number of microcavities are formed on one surface of the tungsten ribbon. A microcavity forming surface is a surface of the tungsten sheet facing up in FIG. 12, and also a surface facing the first detecting surface 23 or the second detecting surface 25 in FIG. 9. In this manner, the surface in which the microcavities are formed faces the first detecting surface 23 or the second detecting surface 25. Thus, most part of radiation from the filaments having a directivity is emitted to the detecting surfaces 23 and 25, so that the total energy efficiency of the gas sensor is increased. In this case, the angle between a line intersecting perpendicularly with the surface of the filament 13 in which the microcavities are formed and the first detecting surface 23 and the angle between a line intersecting perpendicularly with the surface of the filament 14 in which the microcavities are formed and the second detecting surface 24 are substantially 90 degree. If each of the angles is in an 80-100 angle degree range, each of the detecting surfaces 23 and 25 can receive a sufficient high efficient radiation. Note that the microcavities are very small and thus not shown in FIG. 10.

The microcavities formed in the first filament 13 have an opening diameter of 1.7 μm and a hole pitch is 3.4 μm. The microcavities formed in the second filament 14 have an opening diameter of 2.13 μm and a hole pitch is 4.26 μm. Each of the depths of the microcavities formed in the first and second filaments 13 and 14 is twice or more greater than the opening diameters of the microcavities formed in the first and second filaments 13 and 14, respectively. Accordingly, infrared radiation having a spectrum with a peak at the absorption wavelength of methane, i.e., a wavelength of 3.4 μm is emitted from the first filament 13 and infrared radiation having a spectrum with a peak at the absorption wavelength of carbon dioxide, i.e., a wavelength of 4.26 μm is emitted form the second filament 14. Note that these microcavities have been formed using a femto-second laser in the same manner as in EMBODIMENT 1.

The two filaments 13 and 14 are enclosed together with argon gas in a bulb 10. Each of the two filaments 13 and 14, as shown in FIG. 9, is connected to the power source 20 via a switching unit 17. Thus, by switching conductive terminals around in the switching unit 17, measurements of the methane concentration and the carbon dioxide concentration can be switched around without changing the optical system (radiation source 12).

Each of the radiation source 12 of this embodiment and the gas sensor using the radiation source 12 includes the two independent filaments 13 and 14, so that electric conductions to the filaments 13 and 14 can be switched around. Thus, it is possible to flash the first filament 13 to generate radiation having a wavelength around the absorption wavelength of methane at one time and to flush the second filament 14 to generate radiation having a wavelength around the absorption wavelength of carbon dioxide at another time. Accordingly, the concentrations of two types of gases can be measured without preparing a plurality of radiation sources of different types. Therefore, it is possible to measure the concentrations of a plurality gasses of different types by a small-size gas sensor.

Note that the gases to be measured are not limited to methane and carbon dioxide but other gases may be target gases to be measured. In that case, the wavelength of an electromagnetic wave to be absorbed is different depending on the type of a gas to be measured. Therefore, the opening diameter of microcavities in accordance with the absorption wavelength may be selected. Moreover, the two filaments may be conducted at the same time without using the switch unit. Furthermore, a radiation source including three or more filaments may be used.

In EMBODIMENT 1 through 3, if the opening diameter of microcavities is not less than 45% and not more than 55% of the wavelength of an electromagnetic wave absorbed by a gas to be measured, a filament including the microcavities can emit an electromagnetic wave absorbed by the gas with sufficient efficiency for practical use. Therefore, the filament is preferable for application in gas sensors.

Moreover, ELMBODIMENTs 2 and 3, argon gas is filled in the bulb 10. However, a noble gas other than argon gas may be filled or some other gas may be further mixed. As another alternative, the bulb 10 may be a vacuum bulb with no gas enclosed.

In the gas sensor filament of the present invention, a plurality of holes are provided on a surface thereof. The diameter of holes is about half of a wavelength of an electromagnetic wave absorbed by a gas to be measured. Accordingly, the gas sensor filament can effectively emit the electromagnetic wave absorbed by the gas and a small-size and low-cost gas sensor using the filament can be obtained.

1-6. (canceled)

7. A gas sensor for measuring the concentration of a gas, comprising:
a radiation source;
a vessel in which the gas is filled; and
a detector for detecting radiation of an electromagnetic wave from the radiation source,
wherein the radiation source includes a filament in which a plurality of holes having a diameter of about half of a wavelength of an electromagnetic wave absorbed by the gas and which generates the radiation,
wherein the vessel includes an entrance window through which the radiation from the radiation source enters and an exit window through which the radiation is emitted to the detector, and
wherein the detector includes a detecting surface receiving the radiation emitted from the exit window.

8. The gas sensor of claim 7, wherein the radiation source further includes a bulb having, at a reduced pressure or with a noble gas enclosed therein, the filament in an internal space.

9. The gas sensor of claim 7, wherein the filament includes a planar portion,
wherein the holes are provided in the planar portion, and
wherein the planar portion in which the holes are formed faces the detecting surface.

10. The gas sensor of claim 9, wherein the angle between a line intersecting perpendicularly with the planar portion in which the holes are provided and the detecting surface is not less than 80 degree and not more than 100 degree.

11. The gas sensor of claim 7, wherein the gas includes a first gas for absorbing an electromagnetic wave having a first wavelength and a second gas for absorbing an electromagnetic wave having a second wavelength, and
wherein the radiation source includes a first filament in which a plurality of holes having a diameter of about half of the first wavelength are formed and a second filament in which a plurality of holes a diameter of about half of the second wavelength are formed.
